(19) United States
(12) Patent Application Publication
(10) Pub. No.: US 2016/0147605 A1
(43) Pub. Date: May 26, 2016

(54) SYSTEM ERROR RESOLVING METHOD

(71) Applicants: Inventec (Pudong) Technology Corporation, Shanghai City (CN); INVENTEC CORPORATION, Taipei City (TW)

(72) Inventor: Chia-Hsiang CHEN, Taipei City (TW)

(21) Appl. No.: 14/678,481

(22) Filed: Apr. 3, 2015

(30) Foreign Application Priority Data
Nov. 26, 2014 (CN) 201410692252.5

(51) Int. Cl. G06F 11/14

(52) U.S. Cl. CPC G06F 11/1417; G06F 11/1441

(57) ABSTRACT

The present invention provides a system error resolving method including the following steps. In a resolving period of a first system error, determine whether a second system error occurs. When the second system error occurs, a system status is identified. A second error type corresponding to the second system error is identified, wherein a first error type of the first system error and the second error type of the second system error are in association with a first priority value and a second priority value, respectively. According to the first priority value of the first error type and the second priority value of the second error type, the first system error and the second system error are sorted into a resolving sequence.

### CROSS-REFERENCE TO RELATED APPLICATIONS

This non-provisional application claims priority under 35 U.S.C. §119(a) on Patent Application No. 201410692252.5 filed in China on Nov. 26, 2014, the entire contents of which are hereby incorporated by reference.

### BACKGROUND OF THE INVENTION

1. Technical Field of the Invention

The present invention relates to a system error resolving method, particularly to a system error resolving method for a combined error.

2. Description of the Related Art

The conventional system error resolving method usually analyzes the error type of the server system and executes the corresponding resolving mechanism to the error type respectively. However, other system errors may possibly occur when the server system is handling a system error. Moreover, the followed system errors may be more urgent than the system error currently handled by the server system.

For example, when the server system is in the stage of activating the power, standby power activation failure or main power activation failure may occur. When the standby power activation failure occurs, the conventional server system handles the system error of the standby power activation failure in the first priority. However, when a main power activation failure occurs, a more serious error may occur at the same time, but the conventional server system still handles the firstly happened error and then handles the followed error, so that a more serious error or system crash may happen to the server system.

Owing to the problem of the inability of the conventional system to resolve system errors simultaneously or sequentially, a system error resolving method for sorting the resolving sequence when system errors occur simultaneously or sequentially is needed.

### SUMMARY OF THE INVENTION

A system error resolving method adapted for a booting process of a system includes detecting whether a second system error occurs during a resolving period of a first system error, identifying a system status of the system when the second system error is detected, determining a second error type corresponding to the second system error in the system status, wherein a first error type of the first system error is in association with a first priority value and the second error type is in association with the a second priority value, and sorting a resolving sequence for the first system error and the second system error according to the first priority value and the second priority value.

In an embodiment of the present invention, the first error type corresponds to a first error resolving process and the second error type corresponds to a second error resolving process.

In an embodiment of the present invention, the method further includes executing the first error resolving process to the first system error and executing the second error resolving process to the second system error according to the sorted resolving sequence.

In an embodiment of the present invention, the method further includes determining whether the first system error handled by the first error resolving process and the second system error handled by the second error resolving process are resolved, stopping the booting process compulsorily when the first system error handled by the first error resolving process and the second system error handled by the second error resolving process are not resolved, and determining whether the system needs to restart the booting process when the first system error handled by the first error resolving process and the second system error handled by the second error resolving process are resolved.

In an embodiment of the present invention, the step of sorting the resolving sequence for the first system error and the second system error according to the first priority value and the second priority value includes detecting a first resolving period in which the first system error occurs and a second resolving period in which the second system error occurs, adjusting the first priority value and the second priority value according to the first resolving period and the second resolving period, and sorting the resolving sequence for the first system error and the second system error according to the adjusted first priority value and the second priority value.

In an embodiment of the present invention, the step of determining the second error type corresponding to the second system error in the system status includes determining whether the first error type and the second error type are a same power activation error type when the system status is a power activating status, and shutting down and restarting the booting process when the first error type and the second error type are the same power activation error type.

In an embodiment of the present invention, the method further includes detecting whether the first system error occurs during the booting process of the system, identifying the system status of the system when the first system error occurs, determining the first error type of the first system error, and according to the system status and the first error type, executing the first error resolving process to the first system error, wherein the period during the first error resolving process to the first system error is deemed the resolving period of the first system error.

In an embodiment of the present invention, the second system error is triggered by the first system error.

The contents of the present invention set forth and the embodiments hereinafter are for demonstrating and illustrating the spirit and principles of the present invention, and for providing further explanation of the claims.

### BRIEF DESCRIPTION OF THE DRAWINGS

The present invention will become more fully understood from the detailed description given hereinbelow and the accompanying drawings, which are given by way of illustration only and thus are not limitative of the present invention and wherein:

FIG. 1 is a flowchart of the system error resolving method according to an embodiment of the present invention;

FIG. 2 is a flowchart of the system error resolving method according to another embodiment of the present invention;

FIG. 3 is a flowchart of the system error resolving method according to a further embodiment of the present invention; and

FIG. 4 is a flowchart of the system error resolving method according to yet another further embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

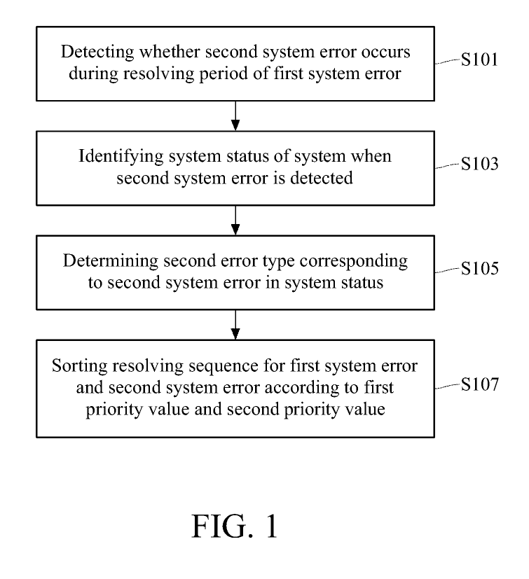

Please refer to FIG. 1. FIG. 1 is a flowchart of the system error resolving method according to an embodiment of the present invention. As shown in FIG. 1, the system error resolving method illustrated in an embodiment of the present invention is adapted for a booting process of a system, and the system is but not limited to a server system, a computer system, or other suitable system. When the system boots, a plurality of processes are started, such as the power activation process, the system activation process, the system heat-dissipation activation process, or other activation process. The processes included in the system booting process are the techniques familiar to persons skilled in the art, and are not further explained hereinafter.

The system error resolving method in an embodiment of the present invention includes the following steps. In the step S101, whether a second system error occurs during a resolving period of a first system error is detected. For example, when a fan anomaly error is the first system error and the system detects the fan anomaly, the system starts to resolve the fan anomaly. During resolving the fan anomaly, the system keeps detecting whether a second system error occurs. For example, the fan anomaly possibly triggers a system error of the heat dissipation anomaly of the microprocessor, and therefore the second system error occurs and is deemed a combined system error by the system. The combined system error occurs when the first system error triggers the second system error, or when the second system error occurs during the resolving period of the first system error. In other words, the first system error and the second system error are sequentially related errors or independent system errors.

In the step S103, a system status of the system is identified when the second system error is detected. For example, the system status is a status indicating that the system is currently executing one of the booting processes. In the step S105, a second error type corresponding to the second system error is determined in the system status, wherein a first error type of the first system error is in association with a first priority value and the second error type is in association with the a second priority value. Because the same second system error may have different priority values in different system statuses, in the step S105, the second error type of the second system error and the second priority value corresponding to the second error type are determined according to the identified system status in the step S103. Before resolving errors in the step S101, the first error type of the first system error and the first priority value corresponding to the first error type are already identified. Therefore, in the step S105, the system is not limited to identify the first error type of the first system error again. In other words, in the step S105, the error type of the first system error is also identified when the system identifies the error type of the second system error.

In the step S107, a resolving sequence is sorted for the first system error and the second system error according to the first priority value and the second priority value. Specifically, in the step S107 after the step S105, the error types of the first system error and the second system error are determined and the resolving sequence is sorted for the first system error and the second system error according to the first priority value of the first system error and the second priority value of the second system error. The first priority value and the second priority value are in association with the seriousness, the priority, or the urgency of the first system error and the second system error. For example, the priority of the power anomaly is greater than the priority of the system activation error, and the priority of the system activation error is greater than the priority of the microprocessor anomaly, and the priority of the microprocessor anomaly is greater than the priority of the heat dissipation anomaly.

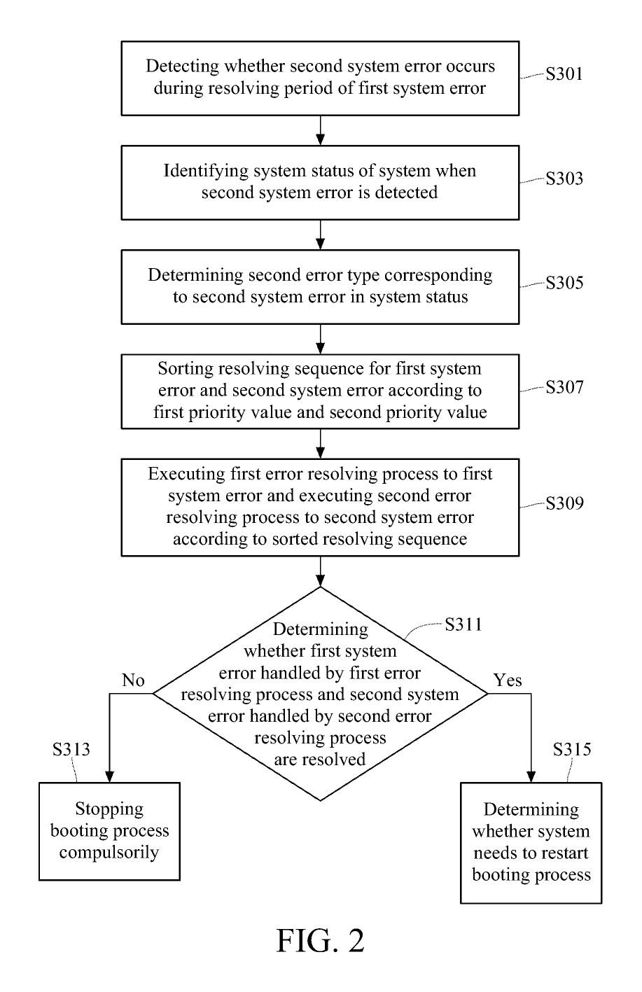

Please refer to FIG. 2. FIG. 2 is a flowchart of the system error resolving method according to another embodiment of the present invention. As shown in FIG. 2, the step S301 to the step S307 are almost the same as the embodiment in FIG. 1 and are not further explained hereinafter. The difference between the embodiments in FIG. 1 and FIG. 2 is that in the step S309, the first error resolving process is executed to the first system error and the second error resolving process is executed to the second system error according to the sorted resolving sequence. The system resolves the first system error and the second system error according to the sorted resolving sequence in the step S307. The first error type of the first system error corresponds to a first error resolving process according to the system status, and similarly, the second error type of the second system error corresponds to a second error resolving process according to the system status. For example, in the step S307, the priority of the second system error is greater than the priority of the first system error. Therefore, in the step S309, the system resolves the second system error in higher priority and then resolves the first system error.

In the step S311, whether the first system error handled by the first error resolving process and the second system error handled by the second error resolving process are resolved is determined. The system determines whether the first system error and the second system error are resolved after the system executes the first error resolving process and the second error resolving process to the first system error and the second system error respectively.

When the system is unable to resolve first system error handled by the first error resolving process and the second system error handled by the second error resolving process, in the step S313, the booting process is stopped compulsorily. In the step S315, when the first system error handled by the first error resolving process and the second system error handled by the second error resolving process are resolved, whether the system needs to restart the booting process is determined.

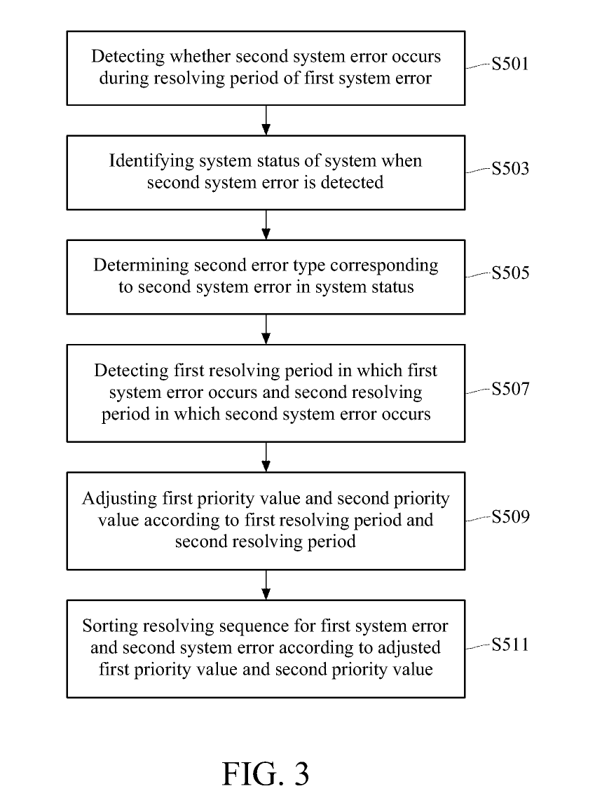

Please refer to FIG. 3. FIG. 3 is a flowchart of the system error resolving method according to a further embodiment of the present invention. As shown in FIG. 3, in the step S501, whether a second system error occurs during a resolving period of the first system error is detected. Next, in the step S503, a system status of the system is identified when the second system error is detected. In the step S505, in the system status, determining a second error type corresponding to the second system error.

In the step S507, a first resolving period in which the first system error occurs and a second resolving period in which the second system error occurs are detected. The first resolving period is the period between the occurrence of the first system error and the current time of the system. The second resolving period is the period between the occurrence of the second system error and the current time of the system.

In the step S509, the first priority value and the second priority value are adjusted according to the first resolving period and the second resolving period. When the time after the system error occurs is longer, the priority of the system error for the system to handle is higher. In the embodiment, in addition to determining the error type of the first system error and the second system error, the system also adjusts the first priority value of the first system error and the second priority value of the second system error according to the precedence of the occurrence of the first system error and the second system error. For example, the system error of the heat dissipation anomaly usually has a lower default priority. Therefore, when the heat dissipation anomaly occurs and the system still handles a plurality of system errors with higher priorities at the same time, the system possibly ignores the heat dissipation anomaly. However, after a period of time, the priority of the heat dissipation anomaly gradually increases. In the step S511, the resolving sequence is sorted for the first system error and the second system error according to the adjusted first priority value and the second priority value.

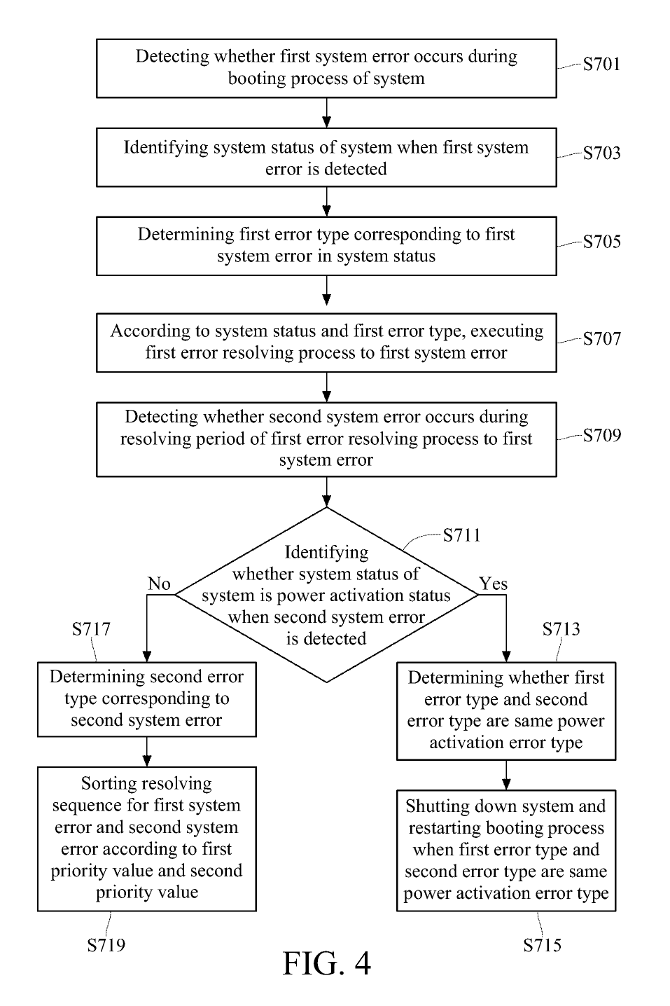

Please refer to FIG. 4. FIG. 4 is a flowchart of the system error resolving method according to yet another further embodiment of the present invention. As shown in FIG. 4, in the step S701, whether the first system error occurs during the booting process of the system is detected. In the step S703, the system status of the system is identified when the first system error occurs. In the step S705, the first error type of the first system error is determined. In the step S707, a first error resolving process is executed to the first system error according to the system status and the first error type. In the step S709, during the period of the execution of the first error resolving process to the first system error, whether the second system error occurs is detected. When the system detects the occurrence of the second system error, in the step S711, whether the system status of the system is the power activating status is determined. When the system status is the power activating status, in the step S713, whether the first error type and the second error type are a same power activation error type is determined. When the first error type and the second error type are the same power activation error type, a serious power activation error possibly occurs in the system. Therefore, in the step S715, when the first error type and the second error type are the same power activation error type, the system is shut down and the booting process is restarted.

When the first error type and the second error type are not the same power activation error type, the system is possibly still available for resolving the system error. Therefore, in the step S717, the second error type corresponding to the second system error is determined. In the step S719, a resolving sequence is sorted for the first system error and the second system error according to the first priority value and the second priority value. Finally, the first error resolving process is executed to the first system error and the second error resolving process is executed to the second system error according to the resolving sequence.

In summary, in an embodiment of the present invention, whether a second system error occurs is also detected when the first error resolving process is executed to the first system error. When the second system error or more system errors occur, a combined error occurs in the system, and the system determines the current system status and sorts the resolving sequence for the first system error and the second system error according to the current system status and the error type of the first system error and the second system error. Finally, the system executes the error resolving processes corresponding to the first system error, the second system error, or other system errors, so that the system not only executes the error resolving processes according to the precedence of the occurrences of the system errors, but also sorts the resolving sequence for the system errors occurred simultaneously or sequentially when a combined error occurs. Therefore, the more serious system error is avoided when resolving the system errors and the system does not create more errors because the serious error is resolved in higher priority.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments of the invention. It is intended, therefore, that the specification and examples be considered as exemplary only, with a true scope and spirit of the invention being indicated by the following claims and their full scope of equivalents.

What is claimed is:

1. A system error resolving method adapted for a booting process of a system, comprising:
detecting whether a second system error occurs during a resolving period of a first system error;
identifying a system status of the system when the second system error is detected;
determining a second error type corresponding to the second system error in the system status, wherein a first error type of the first system error is in association with a first priority value and the second error type is in association with the a second priority value; and
sorting a resolving sequence for the first system error and the second system error according to the first priority value and the second priority value.

2. The method of claim 1, wherein the first error type corresponds to a first error resolving process and the second error type corresponds to a second error resolving process.

3. The method of claim 2, further comprising:
executing the first error resolving process to the first system error and executing the second error resolving process to the second system error according to the sorted resolving sequence.

4. The method of claim 3, further comprising:
determining whether the first system error handled by the first error resolving process and the second system error handled by the second error resolving process are resolved;
stopping the booting process compulsorily when the first system error handled by the first error resolving process and the second system error handled by the second error resolving process are not resolved; and
determining whether the system needs to restart the booting process when the first system error handled by the first error resolving process and the second system error handled by the second error resolving process are resolved.

5. The method of claim 1, wherein the step of sorting the resolving sequence for the first system error and the second system error according to the first priority value and the second priority value comprises:
detecting a first resolving period in which the first system error occurs and a second resolving period in which the second system error occurs;
adjusting the first priority value and the second priority value according to the first resolving period and the second resolving period; and
sorting the resolving sequence for the first system error and the second system error according to the adjusted first priority value and the second priority value.

6. The method of claim 1, wherein the step of determining the second error type corresponding to the second system error in the system status comprises:
determining whether the first error type and the second error type are a same power activation error type when the system status is a power activating status; and
shutting down the system and restarting the booting process when the first error type and the second error type are the same power activation error type.

7. The method of claim 1, further comprising:
detecting whether the first system error occurs during the booting process of the system;
identifying the system status of the system when the first system error occurs;
determining the first error type of the first system error; and
according to the system status and the first error type, executing the first error resolving process to the first system error, wherein the period during the first error resolving process to the first system error is deemed the resolving period of the first system error.

8. The method of claim 1, wherein the second system error is triggered by the first system error.
